(19) United States
(12) Patent Application Publication
(10) Pub. No.: US 2005/0200816 A1
(43) Pub. Date: Sep. 15, 2005

(54) Control method for cooling a projection display

(75) Inventor: Nien-Hui Hsu, Chu-Nan (TW)

Correspondence Address: Min, Hsieh & Hack, LLP;c/o PortfolioIP, P.O. Box 52050, Minneapolis, MN, 55402, US

(73) Assignee: Coretronic Corporation

(21) Appl. No.: 11/076,890

(22) Filed: Mar. 11, 2005

(30) Foreign Application Priority Data
Mar. 12, 2004 (TW) 093106792

(51) Int. Cl. G03B 21/18

(52) U.S. Cl. 353/57

(57) ABSTRACT

A control method for cooling a projection display, wherein the gravity sensor detects the projection display to be a normal status on the desk, a reversely hung status on the ceiling or a laterally hung status on the wall, and then transmit a signal to the control unit for controlling the fan to rotate in the first cooling mode, the second cooling mode or the third cooling mode. The heat distribution inside the projection display varies with the operating status, and the fan generates proper airflow corresponding to various heat distribution for cooling the whole projection display and thus increasing the flexibility in using the projection display, and then increasing the lifetime of each component in the projection display.

### FIELD OF THE INVENTION

The present invention relates to a projection display, and more particularly, to a control method for cooling a projection display.

### BACKGROUND OF THE INVENTION

Generally, a projection display is disposed on a table, on a wall or hangs on the ceiling according to a user's need. As the using way varies, the heat distribution changes. Please refer to FIG. 1. In a conventional desktop projection display 10, a power supply unit 11 provides power for a light source 12 of high power to project an illumination light beam, and the illumination light beam forms an image light beam through an optical system 13, and thereafter the image light beam is projected through a lens 14. Among them, the power supply unit 11 and the light source 12 of high power are the main heat sources, and because the heated air rises, the heat distribution of the projection display is that the temperature of the upper section is higher than the lower section. For increasing the cooling efficiency of a fan 15, the fan 15 is disposed near the upper section of the projection display, that is, above the light source 12 and near the optical system 13. Consequently, the optical components and electrical parts of the projection display 10 maintain the best working efficiency and are prevented from being damaged owing to the heat.

Please refer to FIG. 2. When the projection display 10 is reversely hung on a ceiling 17 by means of a hanging bracket 16, the heated air rises and the heat distribution changes. Nevertheless, the cooling airflow of the fan 15 is fixed and cannot be changed with the heat distribution for cooling the whole projection display appropriately. Thus, the projection display quality of the projection display is lowered.

### SUMMARY OF THE INVENTION

One object of the present invention is to provide a control method for cooling a projection display, wherein a gravity sensor automatically detects the position of the projection display for controlling a fan to generate a corresponding airflow, in order to reach the best cooling efficiency.

Another object of the present invention is to provide a control method for cooling a projection display, wherein there are various cooling modes for increasing the flexibility in using the projection display.

For attaining the above objects, a gravity sensor detects the position of the projection display in the present invention. The gravity sensor detects the projection display to be a normal status on the desk, a reversely hung status on the ceiling or a laterally hung status on the wall, and then transmit a signal to the control unit for controlling the fan to rotate in the first cooling mode, the second cooling mode or the third cooling mode. The heat distribution inside the projection display varies with the operating status, and the fan generates proper airflow corresponding to various heat distribution for cooling the whole projection display and thus increasing the flexibility in using the projection display, and then increasing the lifetime of each component in the projection display.

Further features and advantages of the present invention, as well as the structure and operation of the embodiments of the present invention, are described in detail below with reference to the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view showing a conventional desktop projection display.

FIG. 2 is a lateral view showing a conventional hanging projection display.

FIG. 3 is a perspective view showing the projection display in the present invention.

FIG. 4 is a diagram showing the action of the gravity sensor of the projection display in the invention.

FIG. 5(a) to 5(c) are diagrams showing the actions of the gravity sensor of the projection display in different control modes according to the present invention.

FIG. 6 is a flow chart showing the control method for cooling the projection display in the present invention.

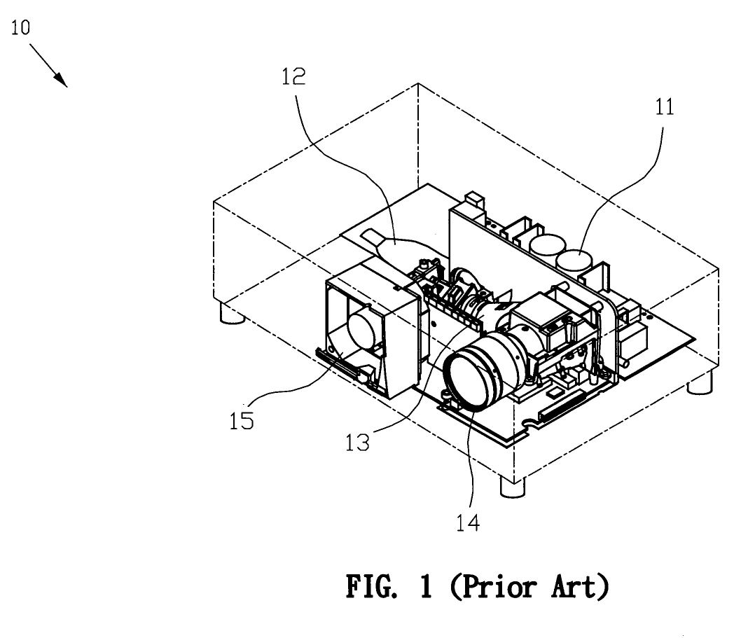

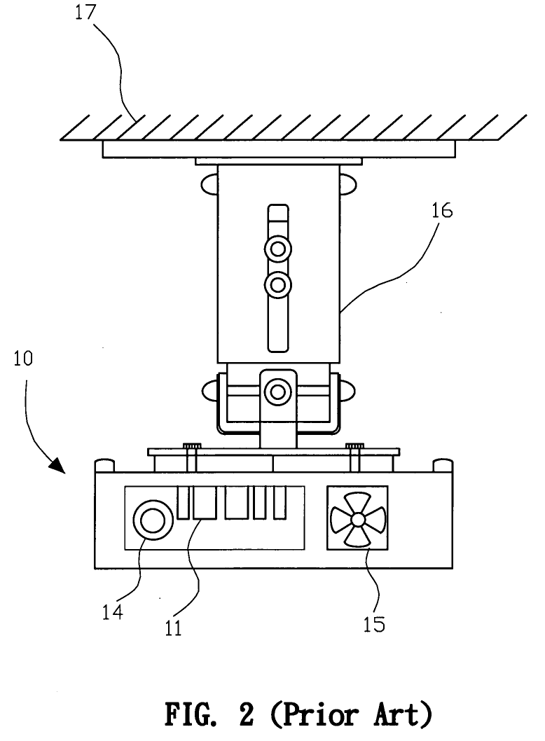

### DETAILED DESCRIPTION OF THE PREFERRED EMBODIMENT

A preferred embodiment of the present invention will be explained with reference to the accompanying drawings.

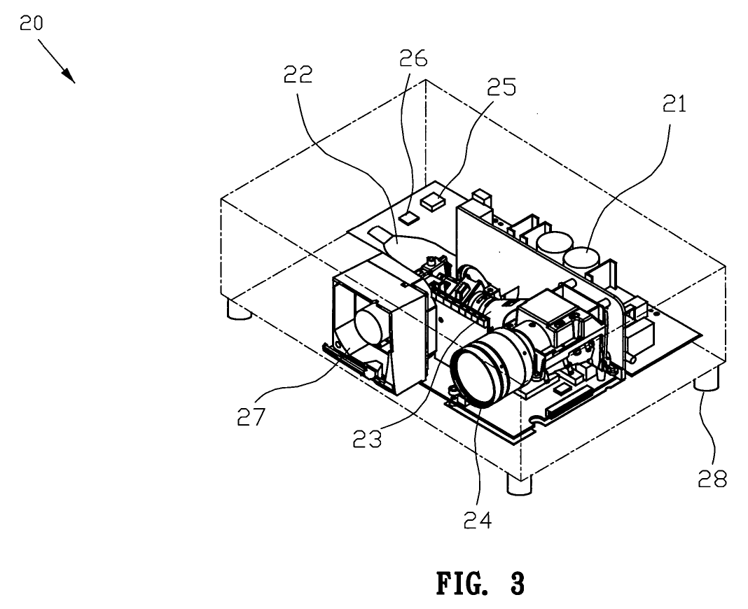

Please refer to FIG. 3. The projection display 20 in the present invention mainly includes a power supply unit 21, a light source 22, an optical system 23, a lens 24, a gravity sensor 25, a control unit 26, a fan 27 and so on. The power supply unit 21 supplies the electrical power for the light source 22 to produce an illumination light beam, and then the optical system 23 modulates the illumination light beam to become an image light beam that is projected through the lens 24. In addition, a gravity sensor 25 such as a gravity switch or a gravity mechanism is disposed inside the projection display for detecting the position of the projection display 20 and transmitting a signal to the control unit 26. The control unit 26 controls the fan 27 to operate in a corresponding cooling mode according to the signal from the gravity sensor 25, and when the projection display 20 is normally disposed, the control unit 26 controls the fan 27 to cool the hotter section inside the projection display 20.

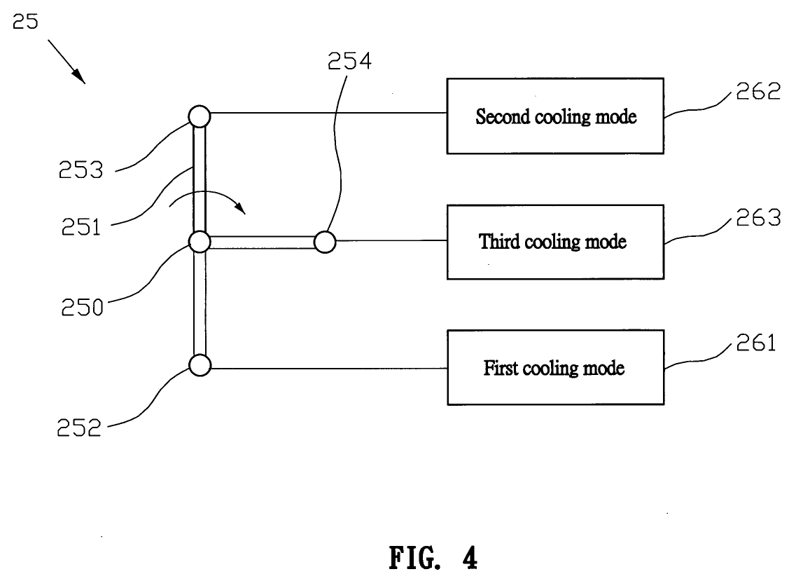

Please continue to refer to FIG. 4. The gravity sensor 25 has a gravity lever 251. One end of the gravity lever 251 is pivoted to the end point 250 and the gravity lever 251 can freely rotate around the end point 250. The end point 250 is taken as the center and the length of the gravity lever 251 as the radius. Three connection points are respectively disposed above, below and horizontal to the end point 250. The first connection point 252 is disposed below the end point 250 and connected to the control circuit of the fan 27 in the first control mode 261. The second connection point 253 is disposed above the end point 250 and connected to the control circuit of the fan 27 in the second control mode 262. The third connection point 254 is disposed horizontal to the end point 250 and connected to the control circuit of the fan 27 in the third control mode 263.

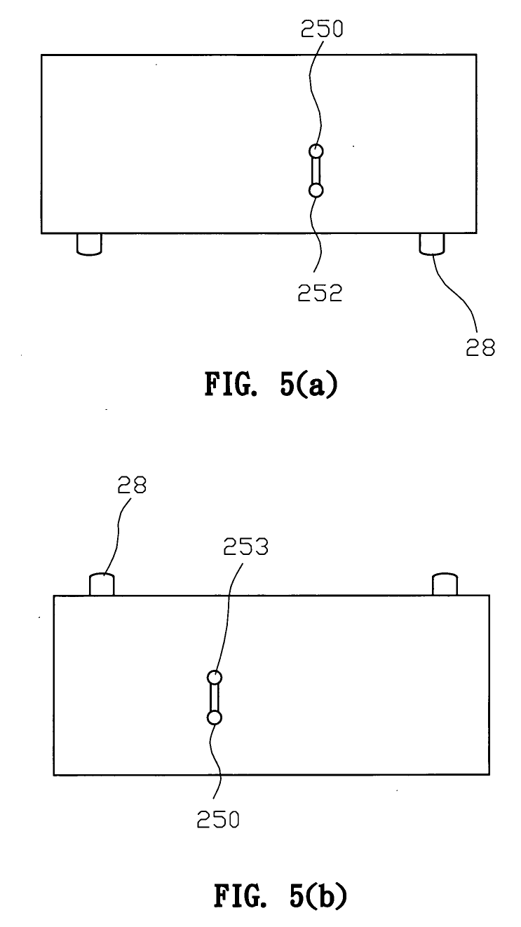

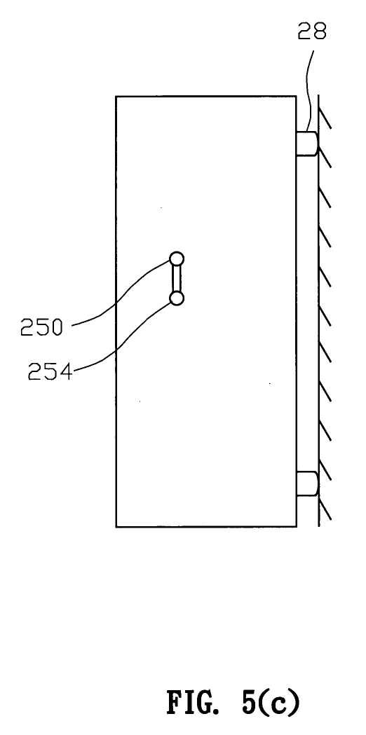

As shown in FIG. 5(a), when the projection display is disposed in a normal position, that is, the foot face 28 is facing down, the gravity lever 251 hangs down due to the gravity force and connects electrically with the first connection point 252. A signal that the projection display 20 is disposed in a normal position is transmitted through the control circuit of the first cooling mode 261 to the control unit 26 for the control unit 26 to output a control signal to control the fan 27 to rotate at a first speed so as to cool the upper section with high temperature inside the projection display 20. As shown in FIG. 5(b), when the projection display 20 is reversely hung, that is, the foot face 28 is facing up, the gravity lever 251 hangs down due to the gravity force and connects electrically with the second connection point 253. A signal that the projection display 20 is reversely hung is transmitted through the control circuit of the second cooling mode 262 to the control unit 26 for the control unit 26 to output a control signal to control the fan 27 to rotate at a second speed, wherein the second speed is faster than the first speed for the fan 27 to provide more airflow in order to cool the high-temperature section near the foot face 28 inside the projection display 20. As shown in FIG. 5(c), when the projection display 20 is laterally hung on a wall, that is, the foot face 28 is facing the wall, the gravity lever 251 hangs down due to the gravity force and connects electrically with the third connection point 254. A signal that the projection display 20 is laterally hung is transmitted through the control circuit of the third cooling mode 263 to the control unit 26 for the control unit 26 to output a control signal to control the fan 27 to rotate at a third speed, wherein the third speed is faster than the second speed for the fan 27 to provide more airflow in order to cool the high-temperature section near the lens 24 inside the projection display 20.

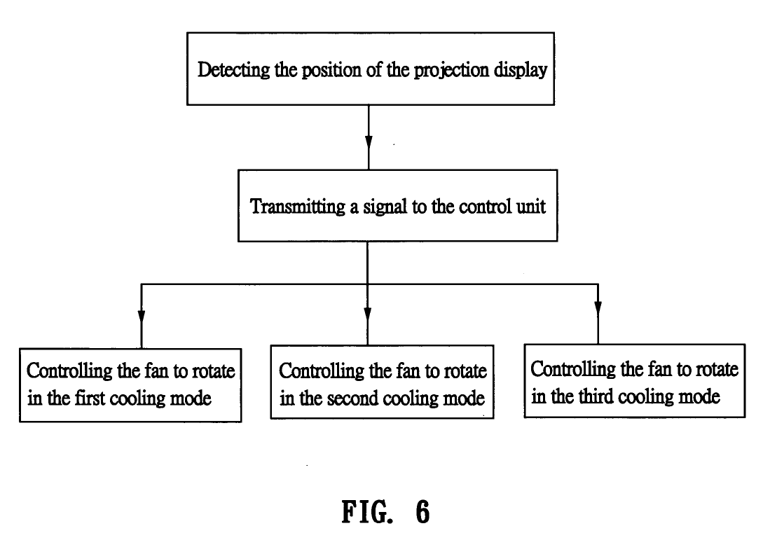

Therefore, according to the control method for cooling a projection display as shown in FIG. 6, the gravity sensor 25 detects the projection display 20 to be a normal status on the desk, a reversely hung status on the ceiling or a laterally hung status on the wall, and then transmit a signal to the control unit 26 for controlling the fan 27 to rotate in the first cooling mode 261, the second cooling mode 262 or the third cooling mode 263. The heat distribution inside the projection display 20 varies with the operating status, and the fan generates proper airflow corresponding to various heat distribution for cooling the whole projection display and thus increasing the flexibility in using the projection display, and then increasing the lifetime of each component in the projection display.

While this invention has been described in the context of a preferred embodiment, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

1. A control method for cooling a projection display, the projection display having a gravity sensor connected to a fan through a control unit, the control method comprising the steps of:
the gravity sensor detecting the position of the projection display;
the gravity sensor transmitting a signal to the control unit; and
the control unit controlling the fan to rotate in a corresponding cooling mode.

2. The control method for cooling a projection display according to claim 1, wherein when the position of the projection display is desktop, the control unit controls the fan to rotate in a first cooling mode.

3. The control method for cooling a projection display according to claim 1, wherein when the position of the projection display is laterally hung, the control unit controls the fan to rotate in a third cooling mode.

4. The control method for cooling a projection display according to claim 1, wherein when the position of the projection display is reversely hung on a ceiling, the control unit controls the fan to rotate in a second cooling mode.

5. The control method for cooling a projection display according to claim 1, wherein the gravity sensor is a gravity switch.

6. The control method for cooling a projection display according to claim 5, wherein the gravity sensor is a gravity mechanism.

7. The control method for cooling a projection display according to claim 1, wherein the gravity sensor has a gravity lever and a plurality of connection points.
